(19) United States
(12) Patent Application Publication
(10) Pub. No.: US 2008/0307032 A1
(43) Pub. Date: Dec. 11, 2008

(54) Divider Circuit

(75) Inventor: Iwao Honda, Gunma-ken (JP)

Correspondence Address: SoCAL IP LAW GROUP LLP, 310 N. WESTLAKE BLVD. STE 120, WESTLAKE VILLAGE, CA, 91362, US

(73) Assignees: Sanyo Electric Co., Ltd., Osaka (JP); Sanyo Semiconductor Co., Ltd., Ora-gun (JP)

(21) Appl. No.: 12/136,542

(22) Filed: Jun. 10, 2008

(30) Foreign Application Priority Data
Jun. 11, 2007 (JP) 2007-154235

(51) Int. Cl. G06F 7/535

(52) U.S. Cl. 708/656

(57) ABSTRACT

A divider circuit for dividing a dividend by a divisor, includes: a multiplicative divisor generating circuit configured to generate 2^{m}-2 multiplicative divisors that are 2 to 2^{m}-1 times the divisor, the m indicating an integer of 2 or more; and a quotient generating circuit configured to sequentially generate a quotient of the dividend, by m bits in decreasing order of significance, by subtracting from the dividend the divisor and the 2^{m}-2 multiplicative divisors, respectively.

### CROSS-REFERENCE TO RELATED APPLICATION

This application claims the benefit of priority to Japanese Patent Application No. 2007-154235, filed Jun. 11, 2007, of which full contents are incorporated herein by reference.

### BACKGROUND OF THE INVENTION

1. Field of the Invention

The present invention relates to a divider circuit.

2. Description of the Related Art

As a method of performing a binary division in a processor, a restoring method or a non-restoring method is generally used. In the case of the restoring method or the non-restoring method, a divisor is successively subtracted from an upper bit of a dividend, and based on a subtraction result, a quotient is evaluated by one bit (for example, JP-A-H10-161854).

Thus, in the case of the restoring method or the non-restoring method, the quotient is obtained only by one bit, and therefore, in accordance with an increase in bit number necessary as the quotient, a processing time until the quotient is evaluated becomes longer.

### SUMMARY OF THE INVENTION

A divider circuit for dividing a dividend by a divisor according to an aspect of the present invention, includes: a multiplicative divisor generating circuit configured to generate 2^{m}-2 multiplicative divisors that are 2 to 2^{m}-1 times the divisor, the m indicating an integer of 2 or more; and a quotient generating circuit configured to sequentially generate a quotient of the dividend, by m bits in decreasing order of significance, by subtracting from the dividend the divisor and the 2^{m}-2 multiplicative divisors, respectively.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram showing a configuration of a divider circuit, which is one embodiment of the present invention;

FIG. 2 is a diagram showing one example of a division process by the divider circuit;

FIG. 3 is a diagram showing a configuration example of a multiplicative divisor generating circuit;

FIG. 4 is a diagram showing a configuration example of a quotient generating circuit;

FIG. 5 is a timing chart showing one example of an operation of the divider circuit; and

FIG. 6 is a diagram showing a configuration example of a divider circuit of a case where a quotient is evaluated by 4 bits.

### DETAILED DESCRIPTION OF THE INVENTION

At least the following details will become apparent from descriptions of this specification and of the accompanying drawings.

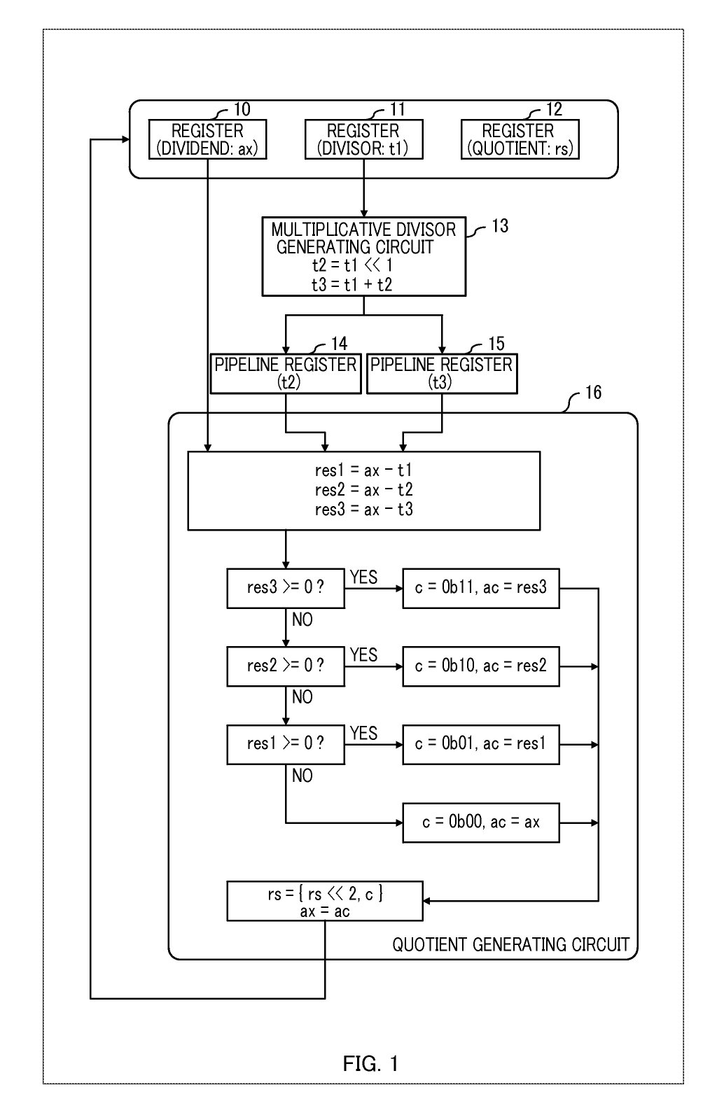

FIG. 1 is a diagram showing a configuration of a divider circuit, which is one embodiment of the present invention. The divider circuit is configured to include: registers 10 to 12; a multiplicative divisor generating circuit 13; pipeline registers 14 and 15; and a quotient generating circuit 16. The divider circuit of the embodiment is configured as a part of a processor such as a CPU (Central Processing Unit).

The registers 10 to 12 are storing regions, each of which stores a dividend, a divisor, and a quotient in a division. The registers 10 to 12 are accumulators, general-purpose registers, special registers, etc., provided in the processor, for example.

The multiplicative divisor generating circuit 13 generates a multiplicative divisor, i.e., a number that is an integral multiple of the divisor stored in the register 11. When the quotient is evaluated by m (an integer of 2 or more) bits in the divider circuit, 2^{m}-2 multiplicative divisors, which are from 2 to 2^{m}-1 times the divisor, are generated in the multiplicative divisor generating circuit 13. The divider circuit shown in FIG. 1 is configured to evaluate the quotient by 2 bits, and thus, in the multiplicative divisor generating circuit 13, multiplicative divisors of from two to three times the divisor are generated. In this case, when t1 is left-shifted by 1 bit, a multiplicative divisor t2 is generated, where t1 denotes the divisor, and t2 and t3 denote the multiplicative divisors of two times and three times. When t1 is added to t2, the multiplicative divisor t3 is generated.

In the pipeline registers 14 and 15, the multiplicative divisors t2 and t3 generated in the multiplicative divisor generating circuit 13 are stored, respectively. The pipeline registers 14 and 15 in the embodiment are configured not as general-purpose registers, etc., whose content is updated by another process, but as registers dedicated to a division process.

The quotient generating circuit 16 uses a dividend ax stored in the register 10 and the multiplicative divisors t2 and t3 stored in the pipeline registers 14 and 15 to evaluate respective results res1 to res3, obtained by subtracting from the dividend the divisor t1 and the multiplicative divisors t2 and t3. Based on the subtraction results res1 to res3, the quotient generating circuit 16 evaluates a partial quotient of 2 bits, which is a part of the quotient obtained by dividing the dividend ax by the divisor t1. More specifically, when the subtraction result res3 is positive (0 or more), a partial quotient c is 0b11, where 0b represents a binary notation. When the subtraction result res3 is negative (less than 0) and the subtraction result res2 is positive, the partial quotient c is 0b10. When the subtraction result res2 is negative and the subtraction result res1 is positive, the partial quotient c is 0b01. When the subtraction result res1 is negative, the partial quotient c is 0b00. Thereafter, the partial quotient c is added to a lower order of a quotient rs.

The partial-quotient generating circuit 16 updates the dividend (minuend) ax based on the subtraction results res1 to res3. More specifically, when all the subtraction results res1 to res3 are negative, the dividend ax remains as such. However, when there is any positive result in the subtraction results res1 to res3, a positive maximum result out of the subtraction results res1 to res3 is the dividend ax.

The processor including the divider circuit of the embodiment is pipelined. An execution stage is to be configured by two stages, i.e., an E1 stage and an E2 stage. The generation of the multiplicative divisor by the multiplicative divisor generating circuit 13 is to be executed at the E1 stage, and that of the quotient by the quotient generating circuit 16 is to be executed at the E2 stage.

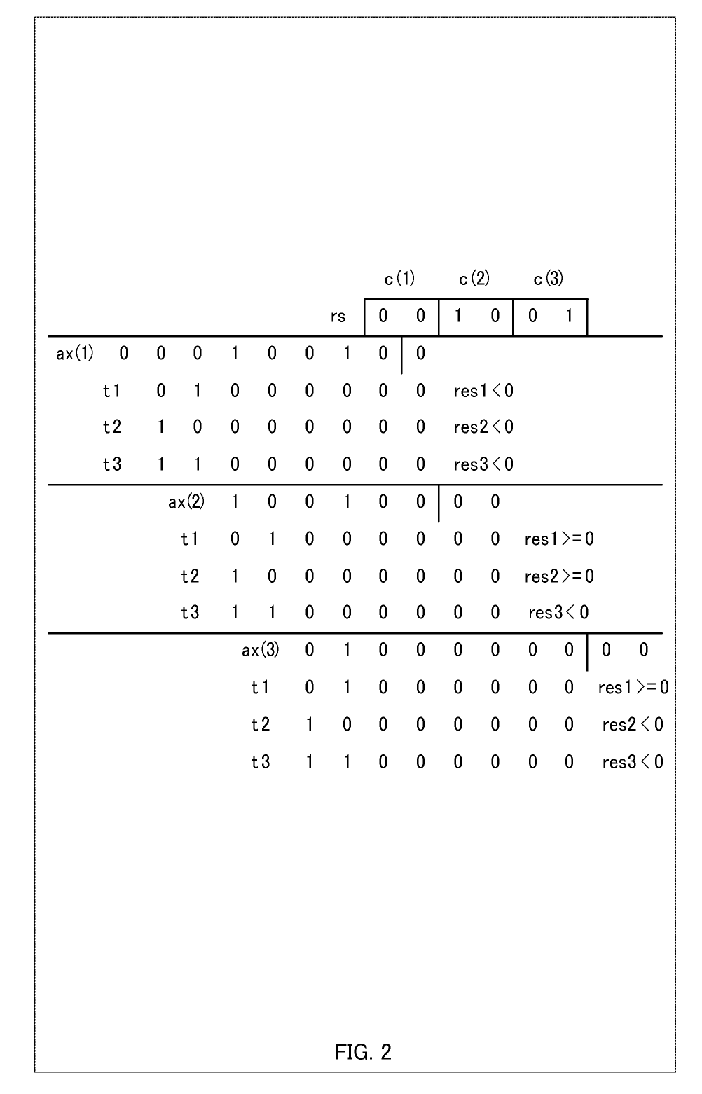

FIG. 2 is a diagram showing one example of the division process by the divider circuit shown in FIG. 1. Herein, the dividend ax is 0b00010010, and the divisor t1 is 0b01000000. The ax and the t1 are fixed-point numbers, and when these are expressed in real numbers, these are ax=0.140625, and t1=0.5, respectively.

Firstly, to evaluate the quotient by 2 bits, 0b0 is added to a lower order of the dividend ax, and this results in the dividend ax(1)=0b000100100. The res1 to res3 obtained by subtracting the divisor t1 and multiplicative divisors t2 and t3 from the dividend ax(1), respectively, are all negative. Therefore, a partial quotient c(1) is 0b00. Subsequently, to evaluate a subsequent 2-bit partial quotient c, 0b00 is added to a lower order of the dividend ax(1). Hence, a dividend ax(2)=0b10010000. With respect to the dividend ax(2), the res1 and the res2 are positive and the res3 is negative. Therefore, a partial quotient c(2) becomes 0b10 which corresponds to the res2. Further, to evaluate a subsequent 2-bit partial quotient c, 0b00 is added to a lower order of the res2. Hence, a dividend ax(3)=0b0100000000. With respect to the dividend ax(3), the res1 is positive, and the res2 and the res3 are negative. Therefore, a partial quotient c(3) becomes 0b01 which corresponds to the res1. Thereby, the quotient rs in which the partial quotients c(1), c(2), and c(3) are arranged in decreasing order of significance results in 0b001001(=0.28125). Thus, when the divider circuit shown in FIG. 1 is used to evaluate the quotient by 2 bits, a 6-bit quotient can be calculated in three cycles.

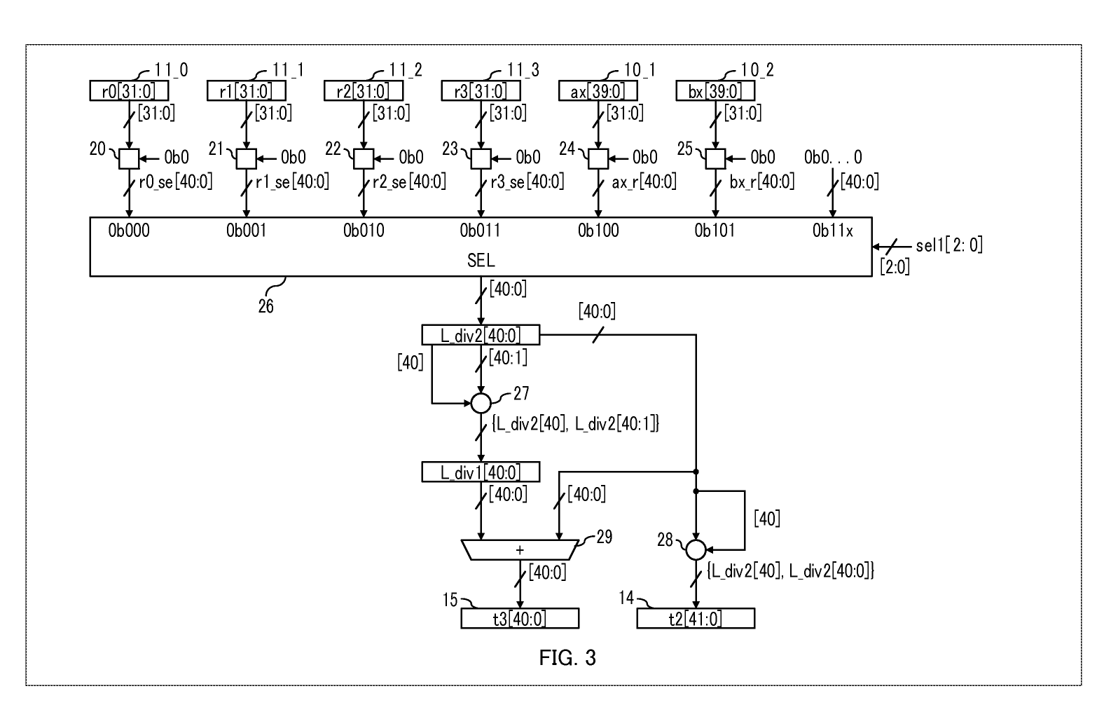

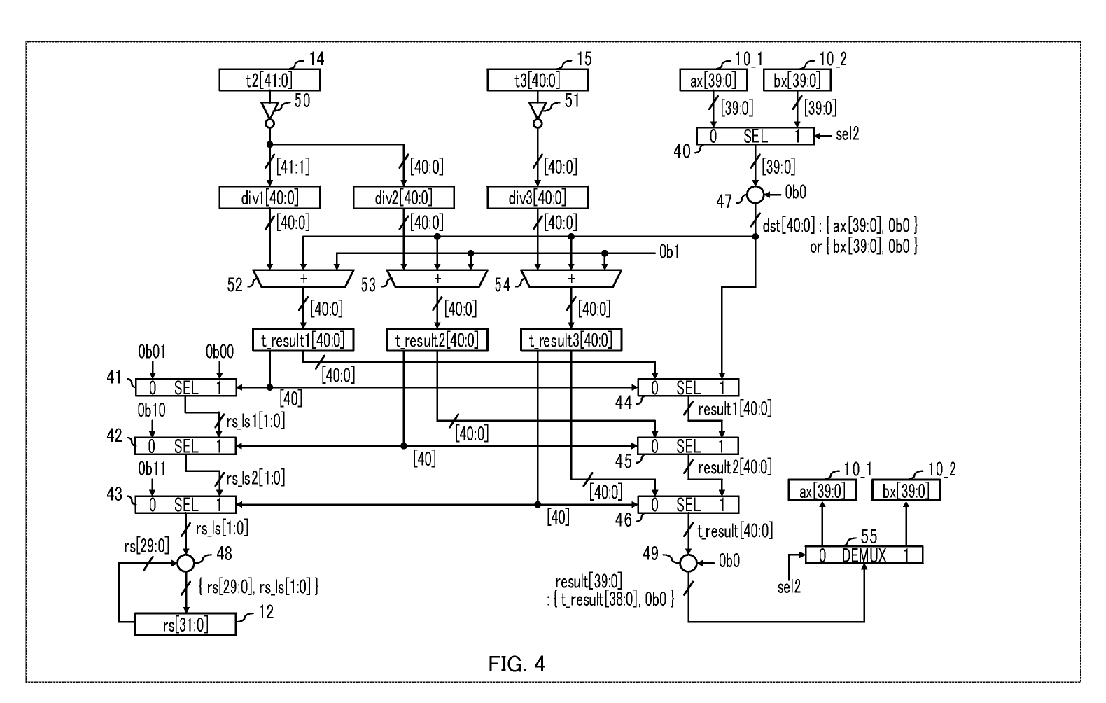

FIG. 3 and FIG. 4 are diagrams each showing a detailed configuration example of the divider circuit shown in FIG. 1. More specifically, FIG. 3 is a diagram showing a configuration example of the multiplicative divisor generating circuit 13. FIG. 4 is a diagram showing a configuration example of the quotient generating circuit 16.

As shown in FIG. 3, the multiplicative divisor generating circuit 13 is configured to include: concatenation expander circuits 20 to 25; a selector 26; concatenating circuits 27 and 28; and an adding circuit 29. Registers 10_1 and 10_2 correspond to the register 10 in which the dividend is stored, and registers 11_0 to 11_3 correspond to the register 11 in which the divisor is stored. In FIGS. 3 and 4, [x:y] represents a bit range of data. For example, [31:0] represents data of 32 bits from 0th bit to 31st bit. In the embodiment, the divisor t1 is stored in any one of the registers 11_0 to 11_3, 10_1, and 10_2.

The concatenation expander circuit 20 adds 0b0 to a lower order of 32-bit data r0 stored in the register 11_0, adds r0[31] to an upper order of r0 by 8 bits, and outputs 41-bit data r0_se. Hence, r0_se[40:0]={r0[31], . . . , r0[31], r0[31:0], 0b0}. Likewise, the concatenation expander circuits 21 to 25 generate 41-bit data r1_se to r3_se, ax_r, and bx_r from lower 32 bits of the data r1 to r3, ax, and bx stored in the registers 11_1 to 11_3, 10_1, and 10_2, and output these data.

The selector 26 accepts the six data output from the concatenation expander circuits 20 to 25 and the data in which all 41-bits are zero, and outputs one 41-bit data corresponding to a 3-bit selection signal sell. For example, when the sell is 0b000, r0_se is output, and when the sell is 0b001, r1_se is output. Data L_div2 output from the selector 26, of which a lower 1-bit is added with 0b0, is the multiplicative divisor t2 obtained by doubling the divisor t1.

The concatenating circuit 27 outputs 41-bit data L_div1 obtained by adding 1-bit L_div2[40] to an upper order of L_div2[40:1]. That is, the L_div1 is the divisor t1 which is ½ times the multiplicative divisor t2. The concatenating circuit 28 outputs 42-bit data in which 1-bit L_div2[40] is added to an upper order of L_div2[40:0], as the multiplicative divisor t2, to the pipeline register 14.

The adding circuit 15 outputs the 41-bit data obtained by adding L_div1 to L_div2, as the multiplicative divisor t3, to the pipeline register 15.

As shown in FIG. 4, the quotient generating circuit 16 is configured to include: selectors 40 to 46; concatenating circuits 47 to 49; inverting circuits 50 and 51; adding circuits 52 to 54; and a demultiplexer 55. In the embodiment, the dividend is stored in any one of the registers 10_1 and 10_2.

The selector 40 outputs one data corresponding to a 1-bit selection signal sel2, out of the two data ax and bx stored in the registers 10_1 and 10_2. In the embodiment, when the selection signal sel2 is 0b0, the ax stored in the register 10_1 is output, and when the selection signal sel2 is 0b1, the bx stored in the register 10_2 is output.

The concatenating circuit 47 adds 0b0 to a lower order of 40-bit data output from the selector 40 and outputs it as 41-bit data dst. The reason for adding 0b0 in this case is to generate the quotient by 2 bits. As a result, dst is the minuend at the time of subtracting the divisor or the multiplicative divisor in a subtraction process.

The inverting circuit 50 inverts and outputs all bits of the 42-bit multiplicative divisor t2 stored in the register 14. Therefore, the div1 which is upper 41 bits of the 42-bit data output from the inverting circuit 50 is one's complementary of the divisor t1, and the div2 which is lower 41 bits thereof is one's complementary of the multiplicative divisor t2. The inverting circuit 51 inverts and outputs all bits of the 41-bit multiplicative divisor t3 stored in the register 15. Therefore, div3 which is the 41-bit data output from the inverting circuit 51 is one's complementary of the multiplicative divisor t3.

The adding circuit 52 adds and outputs dst, div1, and 0b1. That is, 41-bit data t_result1 output from the adding circuit 52 results in that in which the divisor t1 is subtracted from dst which is the minuend. Likewise, the adding circuits 53 and 54 output results t_result2 and t_result3 in which the multiplicative divisors t2 and t3 are subtracted from dst.

The selector 41 accepts 0b01 and 0b00 which are candidates of the partial quotient, and outputs either one of these as rs_ls1 according to a most significant bit of the subtraction result t_result1 output from the adding circuit 52. In the embodiment, when t_result1[40] is 0 (when the subtraction result is positive), 0b01 is output as rs_ls1, and when t_result1[40] is 1 (when the subtraction result is negative), 0b00 is output as rs_ls1. The selector 42 accepts 0b10 which is a candidate of the partial quotient and rs_ls1 which is an output of the selector 41, and when the subtraction result t_result2 is positive, 0b10 is output as rs_ls2 and when the subtraction result t_result2 is negative, rs_ls1 is output as rs_ls2. The selector 43 accepts 0b11 which is a candidate of the partial quotient and rs_ls2 which is output of the selector 42, and when the subtraction result t_result3 is positive, 0b11 is output as rs_ls which is a 2-bit partial quotient, and when the subtraction result t_result3 is negative, rs_ls2 is output as rs_ls. That is, when all the subtraction results t_result1 to t_result3 are negative, 0b00 is output as the partial quotient rs_ls and when there is a positive subtraction result in the subtraction results t_result1 to t_result3, 2-bit data indicating how many times the maximum one of the divisor t1 and the multiplicative divisors t2 and t3 causing the positive subtraction result is larger than the divisor t1, is output as the partial quotient rs_ls (that is, the 2-bit data indicating a factor by which the divisor t1 is multiplied to be the maximum one of the divisor t1 and the multiplicative divisors t2 and t3 associated with the positive subtraction result, is output as the partial quotient rs_is). For example, when all the subtraction results t_result1 to t_result3 are positive, since the multiplicative divisor t3, which is the maximum out of the divisor t1 and the multiplicative divisors t2 and t3, is three times the divisor t1, 2-bit 0b11 indicating 3 is output as the partial quotient rs_ls.

The concatenating circuit 48 stores in the register 12, as a 32-bit quotient rs, the data in which the 2-bit partial quotient rs_ls output from the selector 43 is added to lower 30 bits of the 32-bit quotient rs stored in the register 12.

The selector 44 accepts the subtraction result t_result1 and the minuend dst, and either one of these is output as the result1 according to the most significant bit of the subtraction result t_result1 output from the adding circuit 52. In the embodiment, when t_result1[40] is 0 (when the subtraction result is positive), t_result1 is output as result1, and when t_result1[40] is 1 (when the subtraction result is negative), dst is output as result1. The selector 45 accepts the subtraction result t_result2 and result1 output from the selector 44 are input, and when the subtraction result t_result2 is positive, t_result2 is output as result2, and when the subtraction result t_result2 is negative, result1 is output as result2. The selector 46 accepts the subtraction result t_result3 and result2 output from the selector 45 are input, and when the subtraction result t_result3 is positive, t_result3 is output as t_result, and when the subtraction result t_result3 is negative, result2 is output as t_result. That is, when all the subtraction results t_result1 to t_result3 are negative, dst is output as t_result, and when there is any positive result in the subtraction results t_result1 to t_result3, the minimum positive subtraction result out of the positive subtraction results is output as t_result.

The concatenating circuit 49 outputs, as result, the 40-bit data obtained by adding 0b0 to lower 39 bits of t_result output from the selector 46.

The demultiplexer 55 outputs result to be input to either one of the register 10_1 or 10_2 according to the selection signal sel2 which is the same as in the case of the selector 40. In the embodiment, when the selection signal sel2 is 0b0, result is output to the register 10_1, and when the selection signal sel2 is 0b1, result is output to the register 10_2. That is, the output from the demultiplexer 55 causes the dividend to be updated according to the subtraction results t_result1 to t_result3. When the dividend is updated, also the minuend dst output from the concatenating circuit 47 is updated.

A circuit configured by the inverting circuits 50 and 51 and adding circuits 52 to 54 is one example of a subtracting circuit of the present invention. A circuit configured by the selectors 41 to 43 is one example of a partial-quotient generating circuit and a partial-quotient selecting circuit of the present invention. A circuit configured by the selectors 44 to 46 and the concatenating circuits 47 and 49 is one example of a minuend updating circuit of the present invention. A circuit configured by the selectors 44 to 46 is one example of a subtraction result selecting circuit of the present invention, and that configured by the concatenating circuits 47 and 49 is one example of a minuend generating circuit of the present invention.

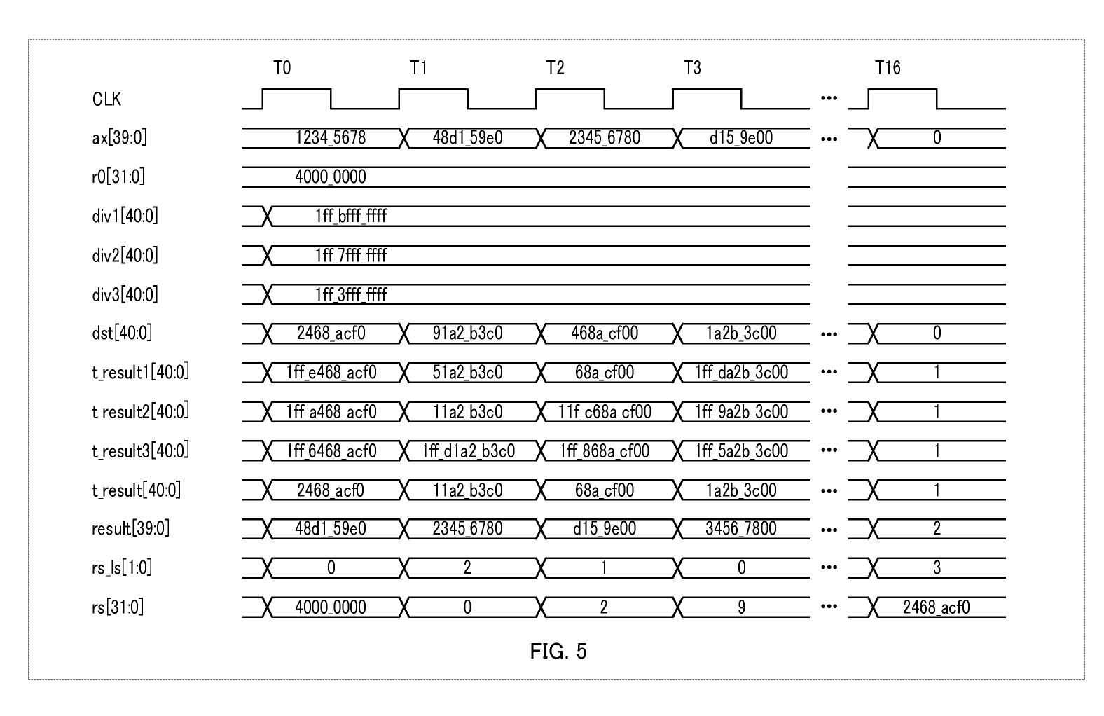

FIG. 5 is a timing chart showing one example of an operation of the divider circuit shown in FIG. 4. In FIG. 5, CLK indicates an operation clock of the divider circuit. In the example of FIG. 5, the dividend is ax stored in the register 10_1, and the divisor is r0 stored in the register 11_0. Numbers shown in FIG. 5 are in hexadecimal notation, and “_” represents a delimiter by 16 bits from a lower order. For example, an initial value 1234_{—}5678 of the dividend ax[39:0] indicates that lower 32 bits of ax[39:0] is 0x12345678. Further, 4000_{—}0000 of the divisor r0[31:0] indicates that r0[31:0] is 0x40000000. It is noted that 0x represents a hexadecimal notation. The dividend ax and divisor r1 are fixed-point numbers, and when these are expressed by real numbers, ax=0.1422222219407558441162109375 and r0=0.5, respectively.

Since the divisor r0 is 4000_{—}0000, div1; div2; and div3 become 1ff_bfff_ffff; 1ff_{—}7fff_ffff; and 1ff_{—}3fff_ffff at a time T0, respectively. Further, since ax is 1234_{—}5678, dst becomes 2468_acf0 at the time T0. At this time, all the subtraction results t_result1 to t_result3 are negative, the partial quotient rs_ls becomes 0(0b00). Therefore, at a time T2, the quotient rs becomes 0(rs[1:0]=0b00). Further, since all the subtraction results t_result1 to t_result3 are negative, at the time T0, the t_result becomes 2468_acf0 (dst) and result becomes 48d1_{—}59e0. Therefore, at the time T1, ax becomes 48d1_{—}59e0 and dst becomes 91a2_b3c0.

When dst becomes 91a2_b3c0 at the time T1, the subtraction results t_result1 to t_result3 become 51a2_b3c0, 1a2_b3c0, and 1ff_d1a2_b3c0, respectively. That is, the subtraction results t_result1 and t_result2 are positive, and the subtraction result t_result3 is negative. Therefore, the partial quotient rs_ls becomes 2(0b10) that corresponds to the positive minimum subtraction result t_result2. Therefore, at the time T2, the quotient rs becomes 2(rs[3:0]=0b0010). Further, 11a2_b3c0 which is the positive minimum subtraction result t_result2 becomes t_result, and result becomes 2345_{—}6780. Therefore, at the time T2, ax becomes 2345_{—}6780, and dst becomes 468a_cf00.

Subsequently, when a process for evaluating the quotient by 2 bits is repeated, 2468_acf0 which becomes a 32-bit quotient rs is obtained at a time T16. This can be expressed by a real number as: rs=0.2844444388151168823242.

Thus, 2^{m}-2 multiplicative divisors of from 2 to 2^{m}-1 times (m is an integer of 2 or more: in the embodiment, m=2) the divisor are generated, and the divisor and the multiplicative divisor are respectively subtracted from the dividend, thereby sequentially generating the quotient by m bits. Therefore, it becomes possible to execute the division process at higher speed as compared to a case where the quotient is sequentially generated by one bit.

Then, as shown in FIG. 4, it becomes possible to configure such that n bits (n is an integer of 2 or more: in the embodiment, n=41) from an upper order of the dividend is the minuend dst, and based on the 2^{m}-1 subtraction results obtained by subtracting each of the divisor and the multiplicative divisor from the minuend, an m-bit partial quotient is evaluated, thereby updating the minuend dst so that a subsequent m-bit partial quotient can be evaluated.

It may also be configured such that based on the 2^{m}-1 subtraction results, when all the subtraction results are negative, an m-bit zero is output as the partial quotient, and when any positive results are included in the subtraction results, out of the positive subtraction results, an m-bit number indicating a multiple of a divisor of a maximum divisor or a divisor of a maximum multiplicative divisor are output as the partial quotient. For example, in FIG. 1, when all the subtraction results res1 to res3 are negative, 0b00 is output as the partial quotient. When the subtraction results res1 and res2 are positive and the subtraction result res3 is negative, since t2 which is the maximum multiplicative divisor out of the positive subtraction results is two times the divisor t1, 0b10 is output as the partial quotient.

Further, a circuit which updates the minuend dst can be configured to output either one of the minuend or the subtraction result based on the subtraction result and output n-bit number, as the minuend, in which m bits are added to lower n-m bits of the output minuend or the subtraction result.

The above embodiments of the present invention are simply for facilitating the understanding of the present invention and are not in any way to be construed as limiting the present invention. The present invention may variously be changed or altered without departing from its spirit and encompass equivalents thereof.

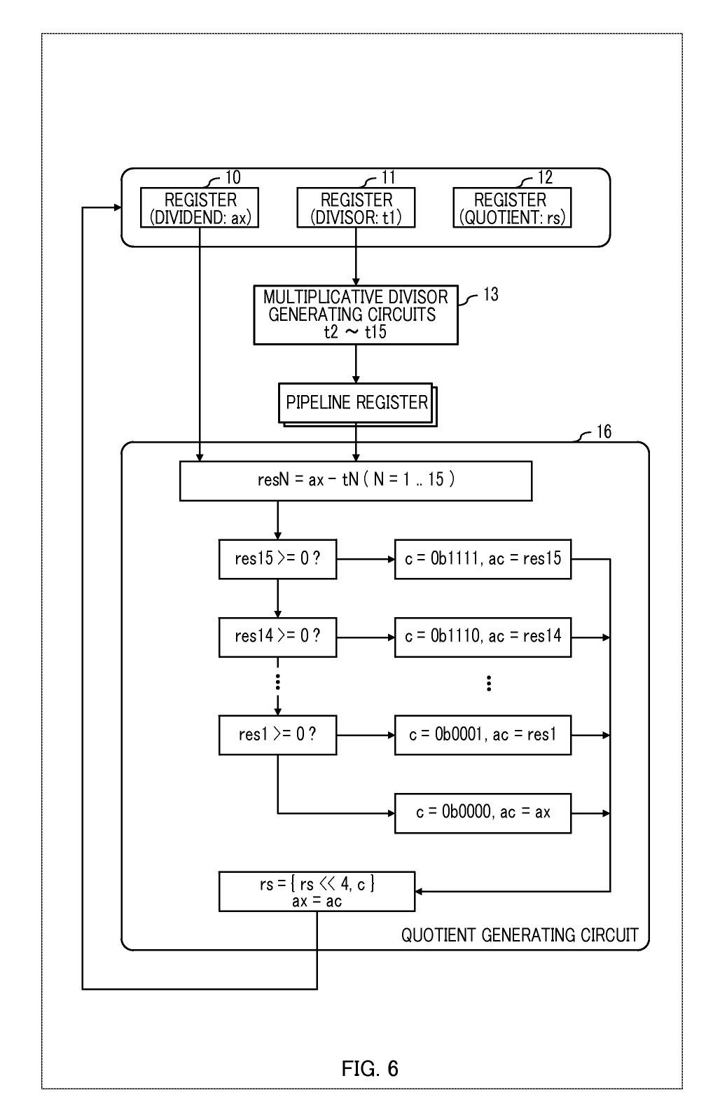

For example, in the embodiment, m=2 and the quotient is evaluated by 2 bits. However, a unit by which the quotient is evaluated is not limited to 2 bits. For example, as shown in FIG. 6, the multiplicative divisors t2 to t15 may be generated by multiplying the divisor t1 by 2 to 15 times, and based on the results res1 to res15 in which the divisor t1 and the multiplicative divisors t2 to t15 are subtracted from the dividend, the quotient may be evaluated by 4 bits.

What is claimed is:

1. A divider circuit for dividing a dividend by a divisor, comprising:
a multiplicative divisor generating circuit configured to generate 2^{m}-2 multiplicative divisors that are 2 to 2^{m}-1 times the divisor, the m indicating an integer of 2 or more; and
a quotient generating circuit configured to sequentially generate a quotient of the dividend, by m bits in decreasing order of significance, by subtracting from the dividend the divisor and the 2^{m}-2 multiplicative divisors, respectively.

2. The divider circuit according to claim 1, wherein
the divisor and the multiplicative divisor are of n bits, the n indicating an integer of 2 or more, and
the quotient generating circuit includes:
a subtracting circuit configured to output 2^{m}-1 subtraction results obtained by subtracting respectively the divisor and the 2^{m}-2 multiplicative divisors as subtrahends from a higher order n-bit dividend of the dividend as a minuend;
a partial-quotient generating circuit configured to generate an m-bit partial quotient that is a part of the quotient of the dividend, based on the 2^{m}-1 subtraction results; and
a minuend updating circuit configured to update the minuend in the subtracting circuit to generate a subsequent m-bit partial quotient of the dividend, based on the dividend and the 2^{m}-1 subtraction results.

3. The divider circuit according to claim 2, wherein
the partial-quotient generating circuit includes a partial-quotient selecting circuit configured
to output an m-bit zero as the partial quotient, when all the subtraction results are negative, and
to output an m-bit number as the partial quotient, the m-bit number indicating a factor by which the divisor is multiplied to be a maximum of the divisor and the multiplicative divisor with the subtraction result that is positive, when any positive subtraction result is included in the subtraction results.

4. The divider circuit according to claim 2, wherein the minuend updating circuit includes:
a subtraction result selecting circuit configured
to output the minuend when all the subtraction results are negative and
to output a positive minimum subtraction result out of the subtraction results when any positive subtraction result is included in the subtraction results; and
a minuend generating circuit configured to output an n-bit number as the minuend, the n-bit number being obtained by adding an m-bit subsequent to n-bit dividend of the dividend to a lower (n-m)-bit minuend of the minuend with n bits or a lower (n-m)-bit positive minimum subtraction result of the positive minimum subtraction result with n bits, output from the subtraction result selecting circuit.

5. The divider circuit according to claim 3, wherein
the minuend updating circuit includes:
a subtraction result selecting circuit configured
to output the minuend when all the subtraction results are negative and
to output a positive minimum subtraction result out of the subtraction results when any positive subtraction result is included in the subtraction results; and
a minuend generating circuit configured to output an n-bit number as the minuend, the n-bit number being obtained by adding an m-bit subsequent to n-bit dividend of the dividend to a lower (n-m)-bit minuend of the minuend with n bits or a lower (n-m)-bit positive minimum subtraction result of the positive minimum subtraction result with n bits, output from the subtraction result selecting circuit.
